(19) United States
(12) Patent Application Publication
(10) Pub. No.: US 2026/0038744 A1
(43) Pub. Date: Feb. 5, 2026

(54) ANODE FOIL FOR SOLID ELECTROLYTIC CAPACITOR, SOLID ELECTROLYTIC CAPACITOR, AND METHOD FOR MANUFACTURING ANODE FOIL FOR SOLID ELECTROLYTIC CAPACITOR

(71) Applicant: Murata Manufacturing Co., Ltd., Nagaokakyo-shi (JP)

(72) Inventor: Junichi SATO, Nagaokakyo-shi (JP)

(21) Appl. No.: 19/317,822

(22) Filed: Sep. 3, 2025

Related U.S. Application Data
(63) Continuation of application No. PCT/JP2024/008766, filed on Mar. 7, 2024.

(30) Foreign Application Priority Data
Mar. 10, 2023 (JP) 2023-037911

(51) Int. Cl. H01G 9/055; H01G 9/00

(52) U.S. Cl. CPC H01G 9/055; H01G 9/0029

(57) ABSTRACT

An anode foil for a solid electrolytic capacitor that includes: a core metal; a porous layer in a sponge shape on the core metal; and one or more through holes in a sponge shape in a part in a plane of the core metal and penetrating the core metal. A method for forming the anode foil is also described.

### CROSS REFERENCE TO RELATED APPLICATIONS

The present application is a continuation of International application No. PCT/JP2024/008766, filed Mar. 7, 2024, which claims priority to Japanese Patent Application No. 2023-037911, filed Mar. 10, 2023, the entire contents of each of which are incorporated herein by reference.

### TECHNICAL FIELD

The present disclosure relates to an anode foil for a solid electrolytic capacitor, a solid electrolytic capacitor, and a method for manufacturing an anode foil for a solid electrolytic capacitor.

### BACKGROUND ART

JP H06-168855 A (“Patent Literature 1”) describes an anode base obtained by roughening a surface into a spongy pit with a through-tunnel pit formed on a valve action metal foil and a cubic pit further formed by alternating current etching.

JP H10-223484 A (“Patent Literature 2”) describes a technique of providing a tunnel-shaped pit and a fine pit on an aluminum foil.

### SUMMARY OF THE DISCLOSURE

To increase the capacity of a solid electrolytic capacitor, increasing the specific surface area by making the solid electrolytic capacitor porous and filling the porous material with a conductive polymer without gaps are required. A conventional anode foil is formed by etching a rolled aluminum foil from a surface layer side by electrolytic etching. Since the core metal (core part) is in an unetched state to maintain the strength, the gas in the voids only escapes to a side surface or the surface side of the porous layer through the connection between the voids at the time of filling with the conductive polymer. When the surface of the porous layer is covered with a conductive polymer, the gas hardly escapes, and there is a problem that it becomes difficult to fill the deep portion of the porous layer with a conductive polymer.

In the through-tunnel pits described in Patent Literatures 1 and 2, adjacent tunnels are likely to be connected to each other like a tear-off line. Thus, the strength of the core metal is likely to decrease. In addition, the tunnel pits have a small enlargement ratio of the specific surface area, and there is a problem that it is difficult to balance the specific surface area and strength.

The present disclosure has been made to solve the above problems, and an object of the present disclosure is to provide an anode foil for a solid electrolytic capacitor, a solid electrolytic capacitor, and a method for manufacturing the anode foil for a solid electrolytic capacitor, which are excellent in the balance between specific surface area and strength as a whole anode foil.

An anode foil for a solid electrolytic capacitor according to the present disclosure includes: a core metal; a porous layer in a sponge shape on the core metal; and a through hole in a sponge shape in a part in a plane of the core metal and penetrating the core metal.

A solid electrolytic capacitor according to the present disclosure includes the anode foil for a solid electrolytic capacitor according to the present disclosure.

A method for manufacturing an anode foil for a solid electrolytic capacitor according to the present disclosure includes: etching a surface of a base material to form a porous layer in a sponge shape; and etching a part in a plane of a core metal of the base material to form a through hole in a sponge shape penetrating the core metal.

The present disclosure can provide an anode foil for a solid electrolytic capacitor excellent in the balance between specific surface area and strength as a whole anode foil, a solid electrolytic capacitor, and a method for manufacturing the anode foil for a solid electrolytic capacitor.

### BRIEF DESCRIPTION OF THE DRAWINGS

FIG. 1 is a sectional view schematically illustrating an anode foil for a solid electrolytic capacitor according to an embodiment of the present disclosure.

FIG. 2 is a perspective view schematically illustrating pits constituting sponge-like through holes in the anode foil for a solid electrolytic capacitor according to the embodiment of the present disclosure.

FIG. 3A is a schematic view illustrating an example of a base material surface in an initial state in which pits are formed by etching. FIG. 3B is a schematic view illustrating an example of a base material surface on which a protective film is formed after etching.

FIG. 3C is a schematic view illustrating an example of a base material surface on which pits are formed again by etching after the protective film is formed. FIG. 3D is a schematic view illustrating an example of a base material surface on which pit formation by etching has progressed without the formation of a protective film.

FIG. 4 is a sectional view schematically illustrating a configuration of a solid electrolytic capacitor according to an embodiment of the present disclosure.

FIG. 5 is an enlarged sectional view illustrating a portion II in FIG. 4.

FIG. 6 is a sectional view of the solid electrolytic capacitor in FIG. 4 as viewed from the direction of the arrow III-III.

### DESCRIPTION OF THE PREFERRED EMBODIMENTS

Hereinafter, an anode foil for a solid electrolytic capacitor, a solid electrolytic capacitor, and a method for manufacturing the anode foil for a solid electrolytic capacitor according to the present disclosure will be described.

The present disclosure is not limited to the following configuration, but can be appropriately modified and applied without changing the gist of the present disclosure. The present disclosure also includes a combination of two or more of individual desirable configurations described below.

### Anode Foil for Solid Electrolytic Capacitor

First, an anode foil for a solid electrolytic capacitor according to an embodiment of the present disclosure will be described.

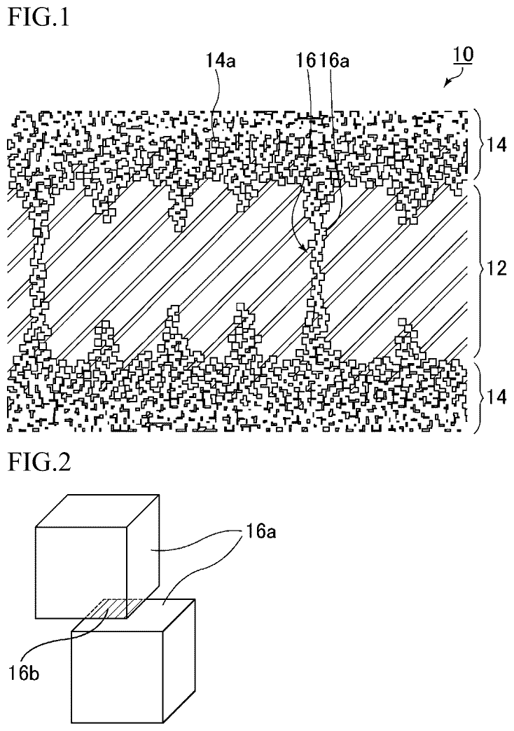

FIG. 1 is a sectional view schematically illustrating an anode foil for a solid electrolytic capacitor according to an embodiment of the present disclosure.

An anode foil 10 for a solid electrolytic capacitor illustrated in FIG. 1 is an electrode foil for an anode of a solid electrolytic capacitor. The anode foil is made of a valve action metal and includes a core metal 12, a pair of porous layers 14, and a plurality of through holes 16.

Examples of the valve action metal include a single metal such as aluminum, tantalum, niobium, titanium, zirconium, magnesium, or silicon, and an alloy containing these metals. Among these, aluminum or an aluminum alloy is preferable.

The core metal 12 is a foil-shaped portion positioned at the center of the anode foil 10 in a thickness direction.

The thickness of the core metal 12 is preferably 5 μm to 100 μm, more preferably 10 μm to 80 μm, still more preferably 15 μm to 40 μm.

The porous layer 14 has a sponge shape, and is preferably an etching layer subjected to electrolytic etching treatment with hydrochloric acid or the like.

The porous layer 14 is provided on each of both principal surfaces of the core metal 12, but it may be provided only on one principal surface of the core metal 12.

The thickness of the porous layer 14 is preferably 5 μm to 200 μm, more preferably 10 μm to 100 μm, still more preferably 20 μm to 70 μm per layer on one surface.

The through hole 16 is a sponge-like through hole that is provided in a part in the plane of the core metal 12 and penetrates the core metal 12. By providing a path penetrating the core metal 12 like this, a path through which gas passes is formed also on the opposite surface with respect to the filling of a conductive polymer from a surface of the anode foil 10, and thus, gas-liquid exchange is easily performed. Thus, filling (impregnation property) of the conductive polymer into the deep portion of the porous layer 14 improves, and the capacitance expression rate of the solid electrolytic capacitor can increase.

In addition, because the through hole 16 has a sponge shape, that is, the sponge structure penetrates the core metal 12, the metal residue is three-dimensionally present also in the through hole 16. Thus, structurally, the through hole 16 is less likely to be connected like a tear-off line (the strength of the core metal 12 is less likely to decrease), and is likely to contribute to an increase in the specific surface area. Therefore, the anode foil 10 as a whole can have a balance between specific surface area and strength. Further, the provision of the sponge-like through hole 16 can decrease the surface expansion magnification of the porous layer 14 as compared with the case where the sponge-like through hole 16 is not provided in the core metal 12.

The sponge-like through holes 16 are dispersedly provided in the plane of the core metal 12. The area proportion of the through holes 16 in the plane of the core metal 12 is not limited. As the proportion increases, the impregnation property of the conductive polymer improves, but when the proportion is too large, the strength of the core metal 12 may not be sufficiently secured. From such a viewpoint, specifically, the area proportion of the through holes 16 in the plane of the core metal 12 is preferably 10% to 90%, more preferably 20% to 60%.

The area proportion of the through holes 16 in the plane of the core metal 12 can be calculated as, for example, the proportion (percentage) of the area of the through holes to an observation area obtained by polishing down to the core metal portion by a method such as mechanical polishing, subjecting an observation image obtained by scanning electron microscope (SEM) observation or the like to image processing to obtain a binarized image, and analyzing the binarized image. Since the brightness in the observation image is clearly different between the core metal portion and the through hole portion, the regions of the portions can be distinguished from each other through binarization.

The area occupied by the sponge-like through hole 16 is preferably 0.025 μm² to 1 μm², and more preferably 0.05 μm² to 0.5 μm² per through hole 16.

The area occupied by the sponge-like through holes 16 can be calculated, for example, by analyzing an observation image obtained by SEM observation or the like as described above, measuring the areas of at least 50 through holes, and calculating the average value (arithmetic average) thereof.

The pit structure constituting the sponge-like through hole 16 may be the same as the pit structure constituting the porous layer 14, but is preferably different.

The pit means one hollow space (cluster) having a single shape, and examples of the pit structure include a shape and a dimension (for example, a diameter) of the pit and a series state of a plurality of pits.

In FIG. 1, both a pit 14a constituting the sponge-like porous layer 14 and a pit 16a constituting the sponge-like through hole 16 are cubic and have the same dimensions, but the dimensions and shapes of the pits 14a and 16a are not limited. For example, the shapes of the pits 14a and 16a may be different from each other, and while the pit 14a constituting the porous layer 14 has a cubic shape, the pit 16a constituting the through hole 16 may have a spherical shape. Such a spherical pit can be obtained, for example, by forming a cubic pit by electrolytic etching and then chemically dissolving the surface of the pit. As will be described later, the cubic pit can be formed by electrolytic etching in which an alternating current is applied.

FIG. 2 is a perspective view schematically illustrating pits constituting a sponge-like through hole in the anode foil for a solid electrolytic capacitor according to the embodiment of the present disclosure.

As illustrated in FIG. 2, the area of an overlapping portion (communication portion) 16b of adjacent cubic pits 16a of the through hole 16 can be enlarged as necessary by chemical dissolution after electrolytic etching. This can further enhance the impregnation property of the conductive polymer.

### Method for Manufacturing Anode Foil for Solid Electrolytic Capacitor

Next, a method for manufacturing an anode foil for a solid electrolytic capacitor according to an embodiment of the present disclosure will be described.

The method for manufacturing an anode foil for a solid electrolytic capacitor according to the present embodiment is a method for manufacturing an electrode foil for an anode of a solid electrolytic capacitor including a porous layer on a surface thereof. The method is suitable for manufacturing the anode foil for a solid electrolytic capacitor according to the present embodiment described above.

In the manufacturing method according to the present embodiment, first, a base material is prepared.

As the base material, a metal foil made of a valve action metal is suitable. Examples of the valve action metal include the above-described materials. As the metal foil, a rolled metal foil is suitable.

The thickness of the base material is preferably 15 μm to 500 μm, more preferably 30 μm to 200 μm.

Next, a surface of the base material is etched to form a sponge-like porous layer. This forms a sponge-like porous layer on at least one principal surface (preferably both principal surfaces) of the core metal. In the present specification, etching means electrolytic etching unless otherwise described. Examples of the electrolytic solution for etching to be used include hydrochloric acid, sulfuric acid, nitric acid, and phosphoric acid.

More specifically, a first etching treatment of etching a surface of the base material to form a sponge-like pit and a first intermediate treatment of forming a protective film on a surface of the pit formed in the first etching treatment are performed. The first etching treatment and the first intermediate treatment are usually performed alternately a plurality of times.

The first etching treatment is performed by first alternating current etching in which a positive current and a negative current are alternately applied to the base material. Specifically, for example, a square wave alternating current is applied to the base material. This can form a sponge-like porous layer including cubic pits. In the first alternating current etching, a sinusoidal alternating current may be applied to the base material.

More specifically, in the case of applying a square wave alternating current, a square wave alternating current having a large amplitude is applied at the initial stage of the etching treatment, and a square wave alternating current having a small amplitude is applied at the latter half of the progressed etching treatment, instead of a simple repetition of square wave. An interval at which the current is not applied is provided while the square wave alternating current is applied. With the variation of the amplitude of the flowing current and the setting of the number and time of intervals, the dispersion state of pits in etching and the degree of progress in the depth direction of etching treatment are changed, and a desired etching state is easily obtained. This also applies to the case of applying a sinusoidal alternating current.

The first etching treatment and the first intermediate treatment for forming a porous layer may be performed in the same manner as the conventional etching treatment and intermediate treatment for forming a sponge-like porous layer.

Next, a part in the plane of the core metal of the base material is etched to form a sponge-like through hole penetrating the core metal. As a result, an anode foil for a solid electrolytic capacitor is completed.

More specifically, a second etching treatment of etching a part in the plane of the core metal to form a sponge-like pit and a second intermediate treatment of forming a protective film on a surface of the pit formed in the second etching treatment are performed. The second etching treatment and the second intermediate treatment are usually performed alternately a plurality of times.

In the first and second intermediate treatments, a coating film that is a complex containing phosphate ions and aluminum is formed on the surface of the base material subjected to the etching treatment by immersing the base material that has undergone the etching treatment in a treatment liquid, for example, an aqueous solution of phosphate. The coating film acts as a protective film. When the etching treatment is continued without performing the intermediate treatment, the pits may be fused with each other to form a large hole, and the surface area may decrease. However, by performing the intermediate treatment during the etching treatment to form the protective film, the progress of local etching with respect to the formed pits is suppressed, and the fusion between the pits is improved (suppressed). In addition, because the progress of local etching is suppressed, dispersibility of the pits is improved, and etching progresses also in the depth direction in the state. Thus, the surface area can be increased. Examples of the protective film formed through the first and second intermediate treatments include, in addition to the complex of phosphoric acid and aluminum, an aluminum hydrate.

The first and second intermediate treatments preferably satisfy at least one of the following conditions (1) to (3).

(1) The number of times of the second intermediate treatment is smaller than the number of times of the first intermediate treatment.

(2) The time of the second intermediate treatment is shorter than the time of the first intermediate treatment.

(3) The concentration of the treatment liquid used for the second intermediate treatment is lower than the concentration of the treatment liquid used for the first intermediate treatment.

This can easily form a sponge-like through hole. More specifically, in general, when a defect portion is present in the protective film, or when the protective film is thin, the defect portion or the thin film portion serves as an active point, to which etching concentrates and progresses in the depth direction of the base material. When the number of times of the intermediate treatment is reduced, the time of the intermediate treatment is shortened, or the concentration of the treatment liquid used for the intermediate treatment is reduced, the uniformity of the protective film degrades, and it becomes difficult to form the protective layer at the back (position closer to the center) of the base material. That is, the protection performance of the surface of the base material degrades, and etching tends to selectively proceed at the back of the base material. Thus, when at least one of the conditions (1) to (3) is satisfied, first, the porous layer is formed with the pits dispersed in the in-plane direction and the depth direction by the first etching treatment involving the first intermediate treatment, and then etching is allowed to progress in a part in the plane from both principal surface sides of the base material in the depth directions to connect the pits by the second etching treatment involving the second intermediate treatment, and sponge-like through holes can be easily formed.

Preferably, the second etching treatment is performed by at least one of (4) second alternating current etching in which a positive current and a negative current are alternately applied to the base material or (5) etching in which only a positive current is intermittently applied to the base material, and the second alternating current etching of (4) satisfies at least one of the following conditions (4A) and (4B).

(4A) The absolute value of the negative current is smaller than the absolute value of the positive current.

(4B) The flowing time of the negative current is shorter than the flowing time of the positive current.

This also can easily form a sponge-like through hole. More specifically, when the porous layer is formed on a surface of the base material by alternating current etching, usually, a protective film (for example, a hydrated film of aluminum) is formed when a positive current is applied (on the cathode side of the alternating current), and the base material (for example, aluminum) is dissolved when a negative current is applied (on the anode side of the alternating current). At this time, when the negative current is not applied, it becomes difficult to protect the already etched porous portion with the protective film and etch the non-etched portion, that is, to disperse the sponge-like pits. Thus, etching locally progresses in the plane of the base material. Thus, in the latter half of the etching for forming the sponge-like through holes, that is, in the second etching treatment, the sponge-like through holes can be easily formed by performing etching with an alternating current waveform in which a negative current becomes small (the conditions (4A), (4B)) and/or performing etching without applying a negative current (the condition (5)).

The second alternating current etching of (4) may be performed, for example, by applying a square wave alternating current applied with a bias voltage in a direction in which a positive current flows. This can form a sponge-like through hole including cubic pits. In addition, the second alternating current etching of (4) may be performed by applying a sinusoidal alternating current applied with a bias voltage in a direction in which a positive current flows.

The etching of (5) is preferably performed in a waveform such as a half wave of square wave alternating current. This also can form a sponge-like through hole including cubic pits. The etching of (5) may be performed in a waveform such as a half wave of sinusoidal alternating current.

When the etching is performed without applying a negative current in the first half of the etching for forming a sponge-like porous layer, that is, in the first etching treatment, the electrostatic capacitance of the solid electrolytic capacitor decreases. Thus, in the first etching treatment, preferably, the alternating current etching is performed by alternately applying a positive current and a negative current to the base material as described above to prevent a decrease in the electrostatic capacitance.

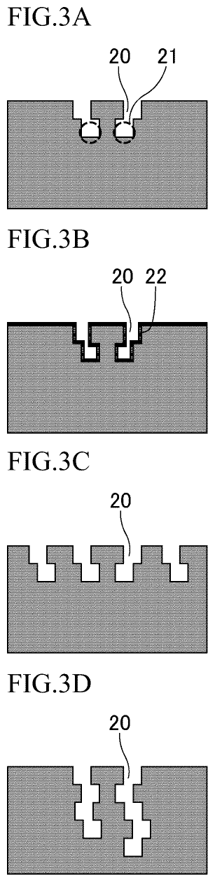

As described above, in the manufacturing method according to the present embodiment, the sponge-like porous layer and the sponge-like through hole can be separately formed by controlling the protective film on the pit. A summary of the principle is illustrated in FIGS. 3A to 3D.

FIG. 3A is a schematic view illustrating an example of a base material surface in an initial state in which pits are formed by etching. FIG. 3B is a schematic view illustrating an example of a base material surface on which a protective film is formed after etching. FIG. 3C is a schematic view illustrating an example of a base material surface on which pits are formed again by etching after the protective film is formed. FIG. 3D is a schematic view illustrating an example of a base material surface on which pit formation by etching has progressed without the formation of a protective film.

When a cubic pit 20 is formed by etching, an active point 21 having high activity is generated at a deeper portion (see FIG. 3A). However, by sufficiently covering the surface of the formed pit 20 with a protective film 22 (see FIG. 3B), pits 20 are dispersedly formed in the plane of the base material in the subsequent etching (see FIG. 3C). On the other hand, when the surface of the pit 20 is not covered with the protective film 22, subsequent etching progresses in the depth direction of the base material, and the pit 20 is locally formed in the plane of the base material (see FIG. 3D).

That is, in the manufacturing method according to the present embodiment described above, basically, in a porous layer formation step, pits are dispersively formed under the surface of the base material by performing etching while sufficiently forming the protective film, and in comparison, in a through-hole formation step, pits are locally formed in the plane of the base material and grown in the depth direction by performing etching while insufficiently forming the protective film (including a case where the protective film is not formed). This can form a sponge-like porous layer on a surface of the base material, and then can easily and continuously form a sponge-like through hole penetrating a part in the plane of the core metal.

### Solid Electrolytic Capacitor

Next, a solid electrolytic capacitor according to an embodiment of the present disclosure will be described.

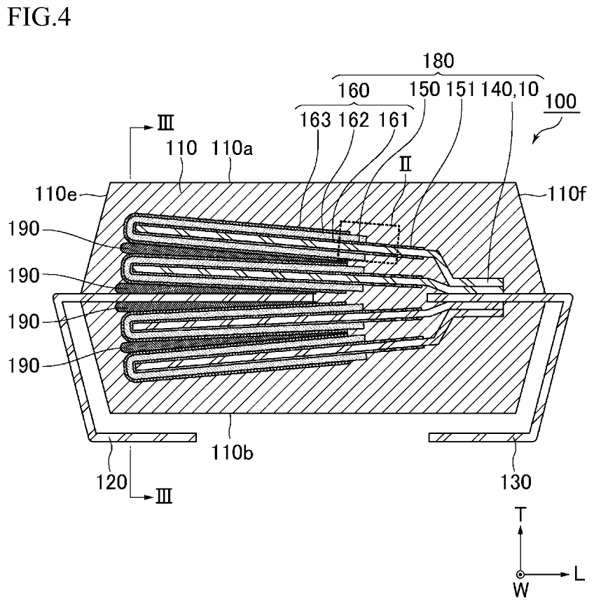

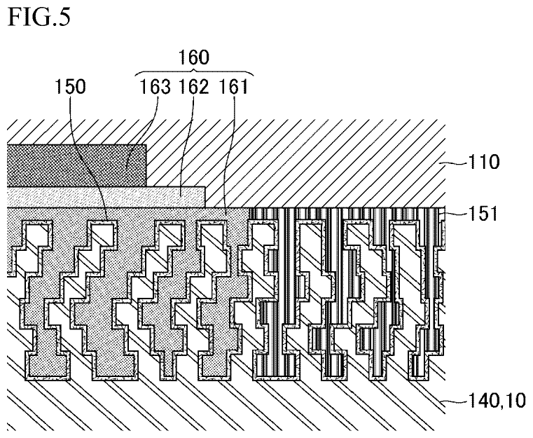

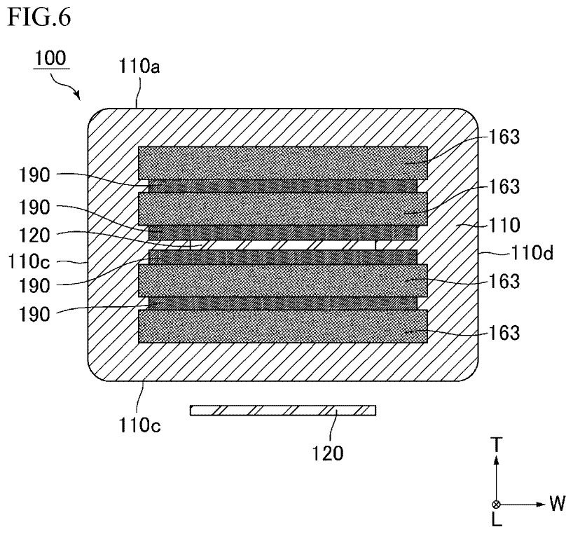

FIG. 4 is a sectional view schematically illustrating a configuration of a solid electrolytic capacitor according to an embodiment of the present disclosure. FIG. 5 is an enlarged sectional view of a part II in FIG. 4. FIG. 6 is a sectional view of the solid electrolytic capacitor in FIG. 4 as viewed from the direction of the arrow III-III. In FIGS. 4 and 6, a length direction of an insulating resin body described later is indicated by L, a height direction of the insulating resin body is indicated by T, and a width direction of the insulating resin body is indicated by W. The height direction Tis orthogonal to the length direction L, and the width direction W is orthogonal to each of the length direction L and the height direction T.

A solid electrolytic capacitor 100 illustrated in FIGS. 4 to 6 has a substantially rectangular parallelepiped outer shape. In the present embodiment, the external dimensions of the solid electrolytic capacitor 100 are, for example, 7.3 mm in the length direction L, 4.3 mm in the width direction W, and 1.9 mm in the height direction T.

The solid electrolytic capacitor 100 includes three or more capacitor elements 180, an insulating resin body 110, a first terminal 120, and a second terminal 130.

Specifically, three or more capacitor elements 180 are provided inside the insulating resin body 110. The insulating resin body 110 has a substantially rectangular parallelepiped outer shape. The insulating resin body 110 includes a first principal surface 110a and a second principal surface 110b facing each other in the height direction T, a first side surface 110c and a second side surface 110d facing each other in the width direction W, and a first end surface 110e and a second end surface 110f facing each other in the length direction L.

The insulating resin body 110 has a substantially rectangular parallelepiped outer shape as described above, but corner portions and ridge portions may be rounded. The corner portion is a portion where three surfaces of the insulating resin body 110 intersect, and the ridge portion is a portion where two surfaces of the insulating resin body 110 intersect. Unevenness may be formed on at least one of the first principal surface 110a, the second principal surface 110b, the first side surface 110c, the second side surface 110d, the first end surface 110e, or the second end surface 110f.

The insulating resin body 110 is made of an insulating resin such as an epoxy resin in which an oxide of glass or silicon is dispersed and mixed as a filler.

Each of three or more capacitor elements 180 includes an anode part 140, a dielectric layer 150, and a cathode part 160. The three or more capacitor elements 180 are stacked on each other in the height direction T.

The anode part 140 is formed of the anode foil 10 for a solid electrolytic capacitor described above.

The dielectric layer 150 is provided on the outer surface of the anode foil 10. In the present embodiment, the dielectric layer 150 is made of an oxide of aluminum. Specifically, the dielectric layer 150 is made of an oxide of aluminum formed by anodizing the outer surface of the anode foil 10.

The cathode part 160 includes a solid electrolyte layer 161 and a current collector layer. The solid electrolyte layer 161 is provided on a part of the outer surface of the dielectric layer 150. The solid electrolyte layer 161 is not provided on the outer surface of the dielectric layer 150 provided on the outer surface close to the second end surface 110f of the anode foil 10, which is positioned on the side opposite to the cathode part 160. In the dielectric layer 150 at this portion, the outer surface of a portion adjacent to the portion where the solid electrolyte layer 161 is provided is covered with an insulating resin layer 151 described later.

As illustrated in FIG. 5, the solid electrolyte layer 161 is provided so as to fill a plurality of recesses of the anode foil 10. The solid electrolyte layer 161 only needs to cover the part of the outer surface of the dielectric layer 150, and there may be a recess of the anode foil 10 not filled with the solid electrolyte layer 161. The solid electrolyte layer 161 is made of a polymer containing a conductive polymer such as poly(3,4-ethylenedioxythiophene).

The current collector layer is provided on the outer surface of the solid electrolyte layer 161. In the present embodiment, the current collector layer includes a first current collector layer 162 provided on the outer surface of the solid electrolyte layer 161 and a second current collector layer 163 provided on the outer surface of the first current collector layer 162. The first current collector layer 162 contains carbon. The second current collector layer 163 contains silver.

As described above, the outer surface of the portion adjacent to the portion where the solid electrolyte layer 161 is provided in the dielectric layer 150 positioned on the side opposite to the cathode part 160 and not provided with the solid electrolyte layer 161 is covered with the insulating resin layer 151 having a composition different from that of the insulating resin body 110.

As illustrated in FIG. 5, the insulating resin layer 151 is provided so as to fill a plurality of recesses on the outer surface at the portion of the anode foil 10 adjacent to the portion where the solid electrolyte layer 161 is provided. The insulating resin layer 151 contains an insulating resin such as a polyimide resin or a polyamideimide resin.

As illustrated in FIGS. 4 and 6, current collector layers of capacitor elements 180 adjacent to each other in a stacking direction are electrically connected to each other by a connection conductor layer 190. The width of the connection conductor layer 190 in the width direction W is equal to the width of the anode foil 10 in the width direction W. The connection conductor layer 190 contains silver.

The ends of the anode foils 10 of the capacitor elements 180 adjacent to each other in the stacking direction close to the second end surface 110f are electrically connected to each other by resistance welding or the like.

The first terminal 120 is a lead frame. The first terminal 120 is electrically connected to the cathode part 160 of each of the three or more capacitor elements 180, and is extended to the outside of the insulating resin body 110. In the first terminal 120, a portion positioned inside the insulating resin body 110 faces the current collector layer of each of two capacitor elements 180 adjacent to each other in the stacking direction, and is connected to each of the current collector layers by the connection conductor layer 190. In the first terminal 120, a portion positioned outside the insulating resin body 110 is bent along the first end surface 110e and the second principal surface 110b of the insulating resin body 110.

The second terminal 130 is a lead frame. The second terminal 130 is electrically connected to the anode part 140 of each of the three or more capacitor elements 180, and is extended to the outside of the insulating resin body 110. In the second terminal 130, a portion positioned inside the insulating resin body 110 is sandwiched between ends of two capacitor elements 180 adjacent to each other in the stacking direction, the ends being close to the second end surface 110f of the anode foil 10, and connected to each of the anode foils 10 by resistance welding or the like. In the second terminal 130, a portion positioned outside the insulating resin body 110 is bent along the second end surface 110f and the second principal surface 110b of the insulating resin body 110.

In the above-described embodiment, a case has been described where a pair of lead frames extended from a pair of end surfaces is used as a pair of terminals (external electrodes) electrically connected to the anode part and the cathode part of each capacitor element. However, in the solid electrolytic capacitor of the present disclosure, a pair of electrode layers formed on a pair of end surfaces may be used as a pair of terminals (external electrodes).

In the above-described embodiment, a chip-type solid electrolytic capacitor has been described, but the solid electrolytic capacitor of the present disclosure may be embedded in a package substrate included in a semiconductor device, for example. Here, examples of the semiconductor device include a semiconductor composite device in which a voltage regulator (voltage control device) and a load are mounted on a package substrate.

### REFERENCE SIGNS LIST

10: anode foil for solid electrolytic capacitor
12: core metal
14: porous layer
14a: pit constituting porous layer
16: through hole
16a: pit constituting through hole
16b: pit overlapping portion
20: pit
21: active point
22: protective film
100: solid electrolytic capacitor
110: insulating resin body
110a: first principal surface
110b: second principal surface
110c: first side surface
110d: second side surface
110e: first end surface
110f: second end surface
120: first terminal
130: second terminal
140: anode part
150: dielectric layer
151: Insulating resin layer
160: cathode part
161: solid electrolyte layer
162: first current collector layer
163: second current collector layer
180: capacitor element
190: connection conductor layer

1. An anode foil for a solid electrolytic capacitor, the anode foil comprising:
a core metal;
a porous layer in a sponge shape on the core metal; and
one or more through holes in a sponge shape in a part in a plane of the core metal and penetrating the core metal.

2. The anode foil for a solid electrolytic capacitor according to claim 1, wherein a first pit structure constituting the one or more through holes is different from a second pit structure constituting the porous layer.

3. The anode foil for a solid electrolytic capacitor according to claim 1, wherein a first pit structure constituting the one or more through holes is the same as a second pit structure constituting the porous layer.

4. The anode foil for a solid electrolytic capacitor according to claim 1, wherein an area proportion of the one or more through holes in the plane of the core metal is 10% to 90%.

5. The anode foil for a solid electrolytic capacitor according to claim 1, wherein an area occupied by the one or more through holes is 0.025 μm² to 1 μm².

6. A solid electrolytic capacitor comprising the anode foil for a solid electrolytic capacitor according to claim 1.

7. A method for manufacturing an anode foil for a solid electrolytic capacitor, the method comprising:
etching a surface of a base material to form a porous layer in a sponge shape; and
etching a part in a plane of a core metal of the base material to form a through hole in a sponge shape penetrating the core metal.

8. The method for manufacturing an anode foil for a solid electrolytic capacitor according to claim 7, wherein
the forming of the porous layer includes:
a first etching treatment of etching the surface of the base material to form a pit in a sponge shape; and
a first intermediate treatment of forming a protective film on a surface of the pit formed by the first etching treatment,
the forming of the through hole includes:
a second etching treatment of etching the part in the plane of the core metal to form a pit in a sponge shape; and
a second intermediate treatment of forming a protective film on a surface of the pit formed by the second etching treatment, and
at least one of conditions (1) to (3) below is satisfied:
(1) a number of times of the second intermediate treatment performed in the forming of the through hole is smaller than a number of times of the first intermediate treatment performed in the forming of the porous layer;
(2) a time for the second intermediate treatment performed in the forming of the through hole is shorter than a time for the first intermediate treatment performed in the forming of the porous layer;
(3) a concentration of a treatment liquid used in the second intermediate treatment performed in the forming of the through holes is lower than a concentration of a treatment liquid used in the first intermediate treatment performed in the forming of the porous layer.

9. The method for manufacturing an anode foil for a solid electrolytic capacitor according to claim 8, wherein
the forming of the porous layer includes a first etching treatment of etching the surface of the base material to form a pit in a sponge shape,
the forming of the through hole includes a second etching treatment of etching the part in the plane of the core metal to form a pit in a sponge shape,
the first etching treatment is performed by first alternating current etching in which a positive current and a negative current are alternately applied to the base material,
the second etching treatment is performed by at least one of:
(4) second alternating current etching in which a positive current and a negative current are alternately applied to the base material or
(5) etching in which only a positive current is intermittently applied to the base material, and
the second alternating current etching of (4) satisfies at least one of conditions (4A) and (4B) below:
(4A) an absolute value of the negative current is smaller than an absolute value of the positive current;
(4B) a flowing time of the negative current is shorter than a flowing time of the positive current.

10. The method for manufacturing an anode foil for a solid electrolytic capacitor according to claim 9, wherein the positive current and the negative current of the first alternating current etching are a square wave alternating current.

11. The method for manufacturing an anode foil for a solid electrolytic capacitor according to claim 9, wherein the positive current and the negative current of the second alternating current etching are a square wave alternating current.

12. The method for manufacturing an anode foil for a solid electrolytic capacitor according to claim 7, wherein
the forming of the porous layer includes a first etching treatment of etching the surface of the base material to form a pit in a sponge shape,
the forming of the through hole includes a second etching treatment of etching the part in the plane of the core metal to form a pit in a sponge shape,
the first etching treatment is performed by first alternating current etching in which a positive current and a negative current are alternately applied to the base material,
the second etching treatment is performed by at least one of:
(1) second alternating current etching in which a positive current and a negative current are alternately applied to the base material or
(2) etching in which only a positive current is intermittently applied to the base material, and
the second alternating current etching of (1) satisfies at least one of conditions (1A) and (1B) below:
(1A) an absolute value of the negative current is smaller than an absolute value of the positive current;
(1B) a flowing time of the negative current is shorter than a flowing time of the positive current.

13. The method for manufacturing an anode foil for a solid electrolytic capacitor according to claim 12, wherein the positive current and the negative current of the first alternating current etching are a square wave alternating current.

14. The method for manufacturing an anode foil for a solid electrolytic capacitor according to claim 12, wherein the positive current and the negative current of the second alternating current etching are a square wave alternating current.
